(19) United States
(12) Patent Application Publication
(10) Pub. No.: US 2002/0015406 A1
(43) Pub. Date: Feb. 7, 2002

(54) Broadband Ethernet multicasting

(76) Inventors: Wei Ming Sun, ZhengHai (CN); Wei Gao, Shanghai (CN); Ying Bo Huang, Shanghai (CN); Hanzhong Gao, Germantown, MD (US)

Correspondence Address: BRIAN C. McCORMACK, BAKER & McKENZIE, SUITE 2300, 2001 ROSS AVENUE, DALLAS, TX, 75201, US

(21) Appl. No.: 09/911,081

(22) Filed: Jul. 20, 2001

(30) Foreign Application Priority Data
Jul. 20, 2000 (CN) 00119490.9

(51) Int. Cl. H04L 12/56

(52) U.S. Cl. 370/390; 370/429

(57) ABSTRACT

A process is provided for broadband Ethernet multicasting in a computer communication network whereby a multicasting service is established enabling multiusers to share a common multicasting address.

### RELATED APPLICATIONS

This application depends and claims priority from People's Republic of China Application No. 00119490.9 (filed Jul. 20, 2000), which is hereby incorporated by reference herein. Related applications filed concurrently herewith are U.S. Utility Application S/N ______ (filed Jul. 20, 2001) entitled “Broadband Ethernet Data Flow Control” and U.S. Utility Application S/N ______ (filed Jul. 20, 2001) entitled “Broadband Ethernet Video Data Transmission”, which are hereby incorporated by reference herein.

### BACKGROUND OF THE INVENTION

The present invention relates to a new solution for network multicasting in computer network communication using broadband Ethernet.

The physical layers for data transmission are Cat 5 (twisted pair) line and Ethernet with the speed of 100 Mega bits per second (Mbps), and fiber optic and broadband Ethernet. As the broadband Ethernet and its related technology develop, the capacity of the broadband Ethernet can already be citywide. In the Ethernet, every terminal has only one unique terminal address, only when the destination address of a data packet matches the terminal address, the terminal will receive the packet. In traditional multicasting, the multicasting organizer's data is sent to different users by changing its destination address accordingly. The prior art solution is only capable for low speed multicasting with little data. As the demand for mega capacity high-speed video data service increases, the traditional solution is no longer capable of the job. The main obstacle is that by sending the same multicasting data packets many times, it adds unnecessary data flow on the network, and wastes bandwidth resources, which in turn costs more overheads and complexes the network management. There are also unpredictable time delays between users when receiving data packets, which affects the quality of the service, especially for services that are time-sensitive.

### SUMMARY OF THE INVENTION

The present invention overcomes the difficulties within the prior art, and provides a simple and effective solution for broadband Ethernet multicasting.

This solution for broadband Ethernet multicasting allows multi-users to share one, i.e., unique or uniformed multicasting address. As the multicasting service establishes, this address will replace the receiving parties' original terminal addresses, thus, enables multi-end users to receive the same packet simultaneously in one transmission.

This invention is a single and effective multicasting solution, which is suitable for usages such as, for example, videoconference, distance education and medical service.

### BRIEF DESCRIPTION OF THE FIGURES

FIG. 1 shows the multicasting network communication.

FIG. 2 shows the multicasting communication process

FIG. 3 shows the address pool in multicasting communication service modules.

FIG. 4 shows sub-network switch multicasting communication process.

### DETAILED DESCRIPTION OF THE INVENTION

According to the present invention, different users i.e. multiusers are able to share one multicasting address. Multiusers or multi-end users as used herein refers to at least two, preferably at least 100 different users. As the multicasting service establishes, this address will replace the original terminal address of the receiving end, in order for different users to receive the multicasting data packet at the same time in one transmission. Since there may be other multicasting services circulating in the network, thus, data overlapping will be prevented. There is no similar copies of multicasting data information in a data trunk. The multicasting process of this invention comprises the following steps.

(a) As the multicasting service begins, an organizer sends a multicasting request to the service module in its sub-network switch, and requests for address distribution.

(b) If the address can be distributed, the service module will choose one spare multicasting address from a local multicasting address pool and distribute the address to the multicasting organizer, and this address will be used to identify the multicasting service.

(c) The service module will call on and authenticate all receiving parties to see whether service can be received, if so, the multicasting address will be notified to all receiving parties by a ‘Multicasting command’ signal sent by the service module, in order to replace their original terminal address, and establish a communication route. The multicasting command signaling is forwarded to each multicasting receipt with their respective terminal address by multiple sending and said signaling comprises a multicasting flag to notify the switches along the way to configure the multicasting routing information into the said multicasting address. When the entire configuration is done, the multicasting virtual path is established.

The multicasting communication module of the related switches will identify the multicasting data by the multicasting flag and the corresponding multicasting address in the specific switches will be retrieved for routing information.

The service module is responsible for the multicasting service regulation and coordination. Each switch has a multicasting communication module to accomplish the service. During the establishment of the multicasting, according to their geographic locations, each related multicasting communication module fill the routing information into content of the address, which has been distributed for the multicasting service. Set “1” represents connection, and set “0” represents disconnection. After the multicasting service is established, the related switch identifies the flag of this multicasting data packet, the packet will then be sent to the multicasting communication module. Later, after authenticating the contents of the specific multicasting address and using the content of “1” to connect packet to the corresponding port of distributor, and because the connection of multi port can be accomplished at the same time, the users can receive the packet simultaneously.

The content of the multi-casting address includes the routing information for each switch. Each bit of the said content corresponds to the each port of the switches indicating the switches to apply CONNECT /DISCONNECT action for a specific port according to the corresponding bit. The ‘1’ of the said bit means CONNECT, ‘0’ means DISCONNECT. The switch is able to apply CONNECT/DISCONNECT for all of its own ports at the same time.

The content of the multi-casting address is set during the multicasting service establishment when all the related switches configure its own routing information into its specific multicasting address.

The allocation of the multicasting address is done by a multi-lever server:

1) The network management as the top lever allocates the non-overlapping multi-casting address to each multicasting service module.

2) The multicasting service module as the next lever allocates its own multicasting address to the multicasting applicant in its own sub-network.

The multicasting service module regulates and coordinate the multicasting service.

The present invention is advanced over existing technology because the multicasting address distribution is done in multi-levels, and so is the address management. Therefore, address distribution and management are simplified. Also, since the invention uses hardware to establish cyber communication route and its unique address management, thus, all multicasting data packets will not need to be opened for software parsing. The solution is simple, minimizing mistakes, and lessening time delay. It is suitable for video multicasting services such as, for example but not limited to, video conference, distance education and medical services.

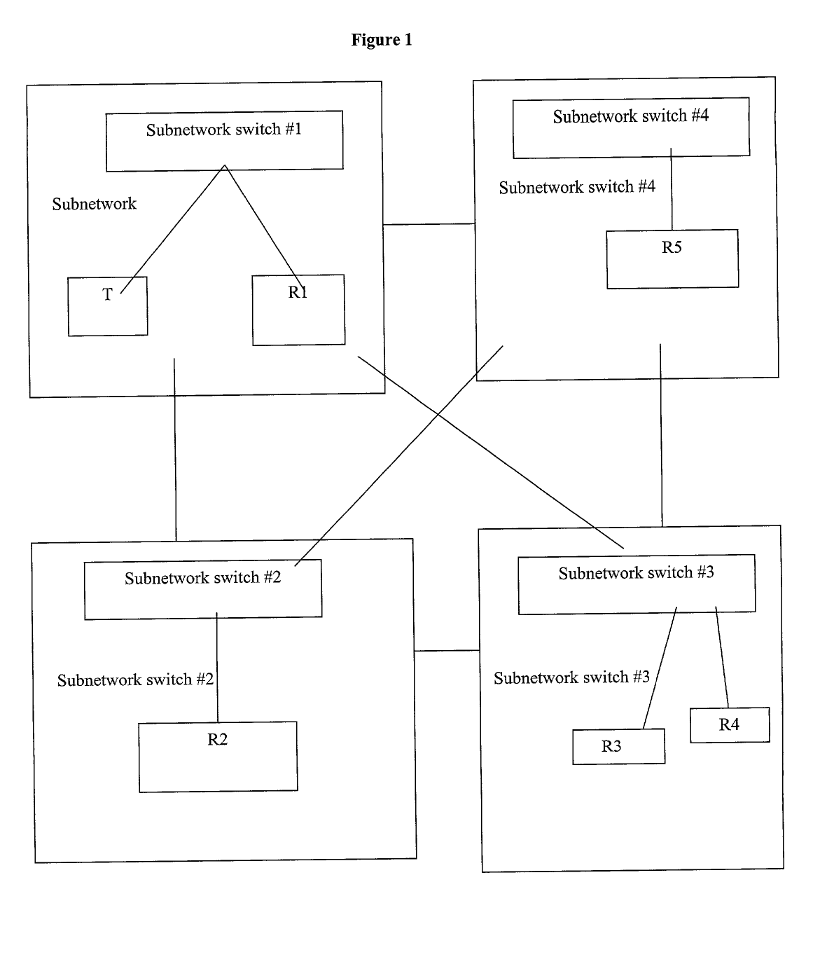

Multicasting is one of the basic services for network communication. One organizer's data can be received by many receiving users. Referring to FIG. 1, the multicasting communication between organizer T in sub-network 1 and receiving user R1 in sub-network 1, R2 in sub-network 2, R3 and R4 in sub-network 3, R5 in sub-network 4. The sub-networks have respective switches involved in communication.

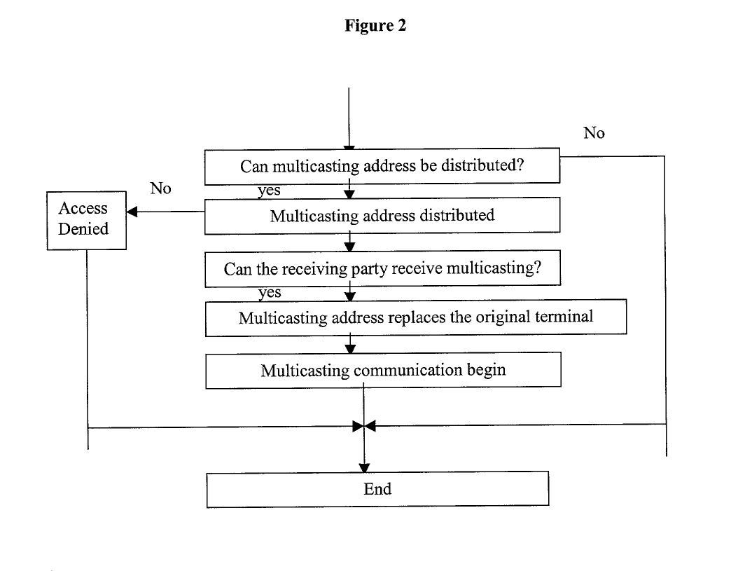

Referring to FIG. 2 the multicasting service establishment procedure is presented. Multicasting communication process can be categorized that as the multicasting service begins, the organizer sends multicasting request to the service module in its sub-network switch, and requests for address distribution. If the address can be distributed, the service module will choose one spare multicasting address from a local multicasting address pool and distribute the address to the multicasting organizer, and this address will be used as the only address for the entire multicasting service. The service module will call on and authenticate all receiving parties to see whether service can be received, if so, the multicasting address will be notified to all receiving parties by the module, in order to replace their original terminal address, add flag on the data packet, and establish communication route.

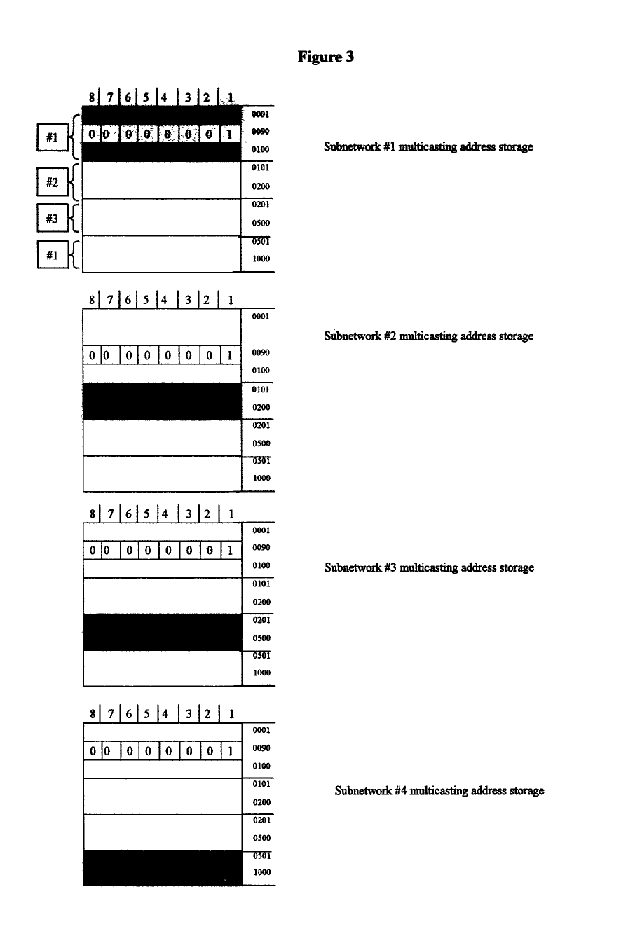

Referring to FIG. 3, sub-network 1 has a multicasting address distributed as 0090, during the establishment of the multicasting service, all sub-network switches must fill in routing information into multicasting address of 0090, according to their locations. Set “1” represents connection, set “0” represents disconnection. Referring to FIG. 1 and FIG. 3, sub-network 3 has bit 3 and 4 of the multicasting address 0090 been set to “1”. After the multicasting service is established, as sub-network switch 3 receives the multicasting flag of the packet, the packet will be sent to the communication module. After checking the content of 0090 in the multicasting address storage by the address analysizer and using the content of this multicasting address to control the distributor, the switch will connect port 3 and 4, a cyber communication route is established so that R3 and R4 can receive the packet at the same time, likewise to all other sub-networks.

Referring to FIG. 3, the multicasting address pool in communication module identifies the multicasting address pool in sub-network 1, 2, 3, and 4. The space of the multicasting address pool is divided into a length of byte groups. The byte numbers in each group are the same as maximum numbers for the switch port in the sub-network. All bit locations are corresponding to the specific port on receiving sub-network switches. As an example, FIG. 3 only draws 8 bits in each group. This storage space is divided longitudinally into N zones (in this case, N=4), N is the number for all sub-networks in the entire network, the serial numbers for each zone are corresponding to all serial numbers for all sub-networks. The numbers of the 8-bit groups included in each zone may not be the same. This number in each group is distributed by the network management according to the working situation of the entire network, in order to prevent wastages. The shadowed area in FIG. 3 is the multicasting address zone distributed by the network management to all sub-networks. In the multicasting communication module in each sub-network, all multicasting address zones are divided as the same, zone 1 is for multicasting requests from users in sub-network 1, and zone 4 is for multicasting requests from users in sub-network 4.

If all addresses are occupied, then new requests from respective sub-networks will be denied. According to the above, it is clear that each serial number for each 8-bit group can only be used for one multicasting service; thus, the address can be used as unique address for multicasting service. The contents of each multicasting address of 8-bit group correspond to the port location of all multicasting receipts in each sub-network. The terminal port serial number in FIG. 3 is the same as the multicasting receipt's number in FIG. 1, that is to say, the routing information is included, therefore, and cyber multicasting communication route can be easily established.

During the above process, the distribution from the network management between all zones and their 8 bit group numbers in the multicasting address pool is called the first class distribution of the multicasting address. For one multicasting request, the byte group number chosen by the multicasting service module (i.e. 0090 in FIG. 3), is called the second-class distribution of the multicasting address.

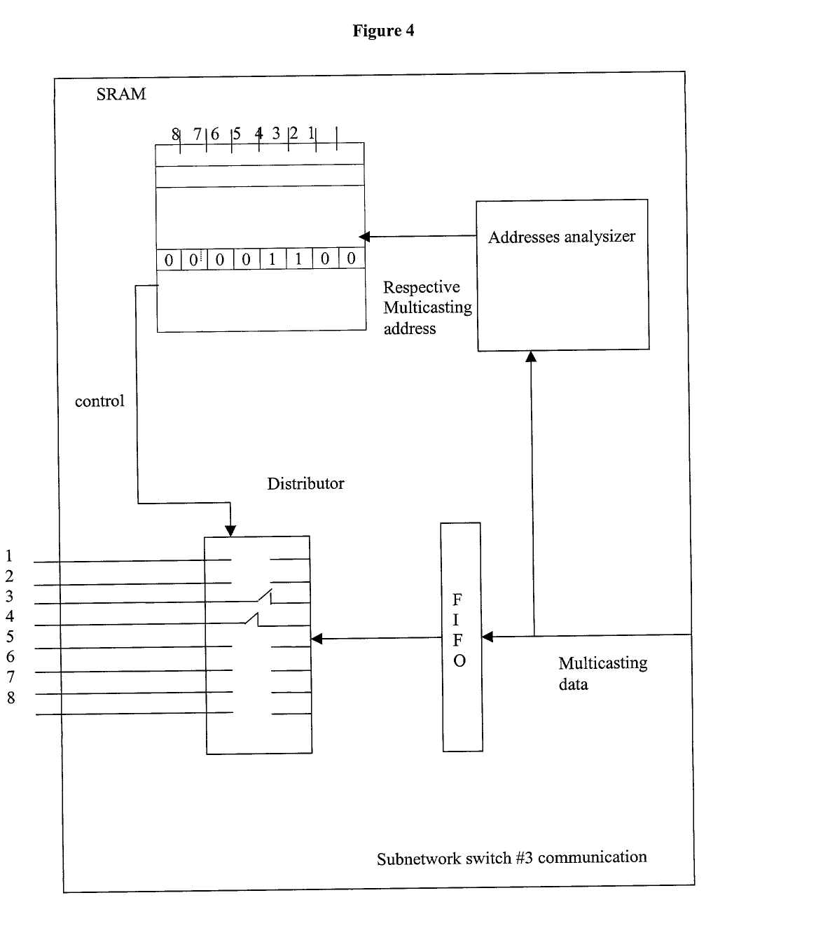

Referring to FIG. 4, the figure only shows the working process in sub-network 3. The head of a stream of multicasting data is copied and redirect to the address analysizer where the multicasting flag will be identified and the multicasting address will be mapped to the multicasting addressing pool for the content where routing information reside, at the same time the head data and the subsequent multicasting data which do not include important information for routing is buffered into the First in First Out (FIFO). The routing information from the multicasting address pool will trigger the CONNECT/DISCONNECT action of the distributor thus the multicasting data packing in the FIFO will connect to the corresponding port simultaneously.

It is to be understood that while the invention has been described in conjunction with the above embodiments, that the foregoing description and the following figures are intended to illustrate and not limit the scope of the invention. Other aspects, advantages and modifications within the scope of the invention will be apparent to those skilled in the art to which the invention pertains.

What is claimed is:

1. A process for broadband Ethernet multicasting comprising the steps of:
(a) establishing a multicasting service whereby a multicasting address replaces an original address of at least one receiving party;
(b) receiving and sharing one multicasting data packet simultaneously among at least 2 multiusers in one transmission.

2. The process of claim 1 wherein the multicasting address is a set of numbers to identify the specific multicasting service.

3. The process of claim 2 wherein the set of numbers is called a multicasting address pool existing in each switches in the network.

4. A multicasting process for establishing multicasting communication comprising the steps of:
(a) requesting a multicasting service module in a sub network to distribute a multicasting address;
(b) choosing one spare multicasting address from a local multicasting address pool and distributing said multicasting address to identify the multicasting service;
(c) authenticating all receiving parties to confirm receipt of the multicasting service;
(d) notifying receiving parties of the multicasting address by a ‘MULTICASTING COMMAND’ signal.

5. The process of claim 4 wherein the multicasting communication module resides in each switches with the function of routing setup in service establishment and routing retrieving in communication procedure.

6. The process of claim 5 further comprising,
A FIFO (First In First Out ) for buffering the multicasting data;
An address analysizer to identify the multicasting flag and map the multicasting address;
A multicasting address pool; and
A distributor to execute a CONNECT/DISCONNECT action.
